(19) United States
(12) Patent Application Publication
(10) Pub. No.: US 2024/0413559 A1
(43) Pub. Date: Dec. 12, 2024

(54) FEMALE TERMINAL, CONNECTOR, TERMINAL-ATTACHED ELECTRIC WIRE, CONNECTOR-ATTACHED ELECTRIC WIRE, AND WIRE HARNESS

(71) Applicants: FURUKAWA ELECTRIC CO., LTD., Tokyo (JP); FURUKAWA AUTOMOTIVE SYSTEMS, INC., Inukami-gun (JP)

(72) Inventors: Takuro YAMADA, Shiga (JP); Takeshi WATANABE, Shiga (JP); Tomoaki TANIGAWA, Shiga (JP); Mitsuko ADACHI, Shiga (JP); Ryosuke NISHII, Tokyo (JP); Junya TAKESHITA, Tokyo (JP); Takahiro IMAMURA, Shiga (JP)

(73) Assignees: FURUKAWA ELECTRIC CO., LTD., Tokyo (JP); FURUKAWA AUTOMOTIVE SYSTEMS, INC., Inukami-gun (JP)

(21) Appl. No.: 18/292,716

(22) PCT Filed: Jul. 26, 2022
(86) PCT No.: PCT/JP2022/028757

§ 371 Date: Aug. 28, 2024

(30) Foreign Application Priority Data
Jul. 27, 2021 (JP) 2021-122419
Aug. 28, 2021 (JP) 2021-139475

(51) Int. Cl. H01R 13/11; H01R 4/02

(52) U.S. Cl. CPC H01R 13/11; H01R 4/029

(57) ABSTRACT

A female terminal includes a terminal body including a base portion to be connected to the electric wire and a spring member to be attached to the base portion. The base portion includes a pair of side walls disposed at a predetermined interval into which a male terminal can be inserted, the spring member includes an inner plate along at least an inner side surface of each of the side walls and an arm spring extending from the inner plate toward the side wall facing the inner plate, and the side wall and the flange plate are welded to form a welded portion. A fulcrum portion of the arm spring abutting the side wall is provided between the welded portion and a contact portion abutting the male terminal.

### BACKGROUND

### 1. Technical Field

The present disclosure relates to a female terminal of an electric circuit through which a large current flows, a connector, a terminal-attached electric wire, a connector-attached electric wire, and a wire harness.

### 2. Description of the Related Art

An electric device conventionally constitutes an electric circuit by connecting an electric device and a power supply device with a wire harness. The wire harness and the electric device as well as the wire harness and the power supply device are connected to each other via connectors attached to the respective devices.

For example, in the connector disclosed in Patent Document 1, a female terminal is housed in a connector housing. In such a female terminal, a terminal body is formed of a base portion and a spring member, and when a male terminal is inserted, an arm spring that is a part of the spring member deform to bend.

### CITATION LIST

### Patent Literature

Patent Document 1: JP 2009-245701 A

### SUMMARY

Meanwhile, since a large current flows in an electric circuit such as a drive system in an automobile, it is conceivable to weld a base portion and a spring member to ensure favorable conductivity. However, not only when the arm spring greatly deforms, but also when the spring member is formed of a thick base material for improving conductivity, flexibility of the arm spring is reduced, and thus there is a possibility that an excessive load acts on a welded portion between the base portion and the spring member.

An object of the present disclosure is to provide a female terminal, a connector, a terminal-attached electric wire, a connector-attached electric wire, and a wire harness capable of preventing an excessive load from acting on a welded portion between a base portion and a spring member.

The present disclosure is a female terminal including a terminal body, the terminal body including a base portion to be connected to an electric wire, and a spring member to be attached to the base portion, in which the base portion includes a pair of side walls disposed at a predetermined interval into which a male terminal can be inserted, the spring member includes a laying plate along at least an inner side surface of each of the side walls and an arm spring extending from the laying plate toward the side wall facing the laying plate, the side wall and the laying plate are welded to form a welded portion, and a fulcrum portion of the arm spring abutting the side wall is provided between the welded portion and a contact portion of the arm spring.

The contact portion in the present disclosure refers to a portion at a distal end of the arm spring, the portion abutting a male terminal in a state where the male terminal is inserted inside the female terminal. The fulcrum portion in the present disclosure refers to a portion at a proximal end of the arm spring, the portion abutting a side wall in a state where a male terminal is inserted at least inside the female terminal. Further, the term “between the welded portion and the contact portion of the arm spring” in the present disclosure refers to a range sandwiched between the welded portion and the contact portion in a state where the spring member formed by bending the base material is developed in a flat plate shape.

The present disclosure also includes a connector including the female terminal and a connector housing that houses the female terminal, and a terminal-attached electric wire including the female terminal and the electric wire connected to the base portion of the female terminal.

The present disclosure further includes a connector-attached electric wire including the terminal-attached electric wire and a connector housing that houses the terminal-attached electric wire, and a wire harness including at least one of the terminal-attached electric wire and the connector-attached electric wire.

The present disclosure can prevent an excessive load from acting on the welded portion between the base portion and the spring member.

More specifically, in the female terminal and the like according to the present disclosure, a fulcrum portion of the arm spring abutting the side wall is provided between the welded portion and the contact portion of the arm spring. According to such a configuration, even when the contact portion is pushed by the insertion of the male terminal, the fulcrum portion is not displaced in a state of abutting the side wall, and thus the arm spring deforms on the contact portion side from the fulcrum portion, which suppresses the deformation of the laying plate on the welded portion side from the fulcrum portion. Thus, it is possible to prevent an excessive load from acting on the welded portion between the side wall and the laying plate. In other words, it is possible to prevent an excessive load from acting on the welded portion between the base portion and the spring member.

In addition, since the fulcrum portion reliably abuts the side wall of the base portion, a current flows through a short path. That is, when a current flows from the male terminal to the female terminal, the current flows from the contact portion abutting the male terminal to the side wall via the arm spring and through the fulcrum portion. When a current flows from the female terminal to the male terminal, the current flows from the fulcrum portion abutting the side wall to the male terminal via the arm spring and through the contact portion. Thus, electric resistance at these terminals can be held low. Such a structure can be said to be a structure particularly suitable for an electric circuit through which a large current flows.

As an aspect of the present disclosure, the laying plate may be disposed along a distal end surface of the side wall, and the laying plate may be welded to the distal end surface of the side wall.

The distal end surface in the present disclosure refers to a surface intersecting an insertion direction of the male terminal in at least one side wall of the pair of side walls. The laying plate in the present disclosure is a part of the spring member disposed along the distal end surface of the side wall so as to cover the distal end surface of the side wall, and it corresponds to a flange plate to be described later.

According to the present disclosure, even when the contact portion is pushed by the insertion of the male terminal, the fulcrum portion is not displaced in a state of abutting the side wall, and thus the arm spring deforms on the contact portion side from the fulcrum portion, which suppresses the deformation of the laying plate on the welded portion side from the fulcrum portion. In addition, even when a load acts on the laying plate along the inner side surface of the side wall due to the moment about the fulcrum portion, the load does not affect the laying plate along the distal end surface of the side wall. Thus, it is possible to prevent an excessive load from acting on the welded portion between the side wall and the laying plate. In other words, it is possible to prevent an excessive load from acting on the welded portion between the base portion and the spring member.

In addition, since the distal end surface of the side wall and the laying plate along the distal end surface are surfaces intersecting with the insertion direction of the male terminal, the welding machine that performs these welding can freely approach and move. Thus, such a welding step can be easily realized. In this regard, the portion where the laying plate overlaps the distal end surface of the side wall has a shape having a narrow width and a long length, and thus it is preferable to perform linear or dotted welding.

As an aspect of the present disclosure, the laying plate may be disposed along an outer side surface of the side wall, and the laying plate may be welded to the outer side surface of the side wall.

The outer side surface in the present disclosure refers to a surface of at least one side wall of the pair of side walls, the surface being on the opposite side of the surface facing a side surface of the male terminal. The laying plate in the present disclosure is a part of the spring member disposed along the outer side surface of the side wall so as to cover the outer side surface of the side wall, and it corresponds to an outer plate to be described later.

According to the present disclosure, even when the contact portion is pushed by the insertion of the male terminal, the fulcrum portion is not displaced in a state of abutting the side wall, and thus the arm spring deforms on the contact portion side from the fulcrum portion, which suppresses the deformation of the laying plate on the welded portion side from the fulcrum portion. In addition, even when a load acts on the laying plate along the inner side surface of the side wall due to the moment about the fulcrum portion, the load does not affect the laying plate along the outer side surface of the side wall. Thus, it is possible to prevent an excessive load from acting on the welded portion between the side wall and the laying plate. In other words, it is possible to prevent an excessive load from acting on the welded portion between the base portion and the spring member.

In addition, since the outer side surface of the side wall and the laying plate along the outer side surface are surfaces on the opposite side of the surface facing a side surface of the inserted male terminal, the welding machine that performs these welding can freely approach and move. Thus, such a welding step can be easily realized. In this regard, the portion where the laying plate overlaps the outer side surface of the side wall has a shape having a wide width and a long length, and thus any welding mode can be applied.

As an aspect of the present disclosure, the laying plate may be disposed along an inner side surface of the side wall, and the laying plate may be welded to the inner side surface of the side wall.

The inner side surface in the present disclosure refers to a surface of at least one side wall of the pair of side walls, the surface facing a side surface of the male terminal. The laying plate in the present disclosure is a part of the spring member disposed along the inner side surface of the side wall so as to cover the inner side surface of the side wall, and it corresponds to an inner plate to be described later.

According to the present disclosure, even when the contact portion is pushed by the insertion of the male terminal, the fulcrum portion is not displaced in a state of abutting the side wall, and thus the arm spring deforms on the contact portion side from the fulcrum portion, which suppresses the deformation of the laying plate on the welded portion side from the fulcrum portion. In addition, since the laying plate is welded to the inner side surface of the side wall, deformation of the laying plate can be suppressed by devising the welding mode. Thus, it is possible to prevent an excessive load from acting on the welded portion between the side wall and the laying plate. In other words, it is possible to prevent an excessive load from acting on the welded portion between the base portion and the spring member.

As an aspect of the present disclosure, the welded portion in at least one side wall of the pair of side walls may include a plurality of welded portions or a plurality of welded points.

The plurality of welded points in the present disclosure refer to a plurality of linear or curved welded points. However, these welded points are not limited to welded points being parallel to each other. The plurality of welded points in the present disclosure refer to a plurality of welded points having a solid line shape, a dotted line shape, or a point group shape. However, the shape of each welded point is not limited.

The present disclosure can prevent a load from concentrating on a specific welded portion. In addition, even when a load is concentrated on a specific welded portion and the welded portion is broken or the like, it is possible to prevent the welded portion from being broken or the like as a whole. Thus, conductivity can be stabilized. Further, a parallel circuit is configured locally because a current flows through corresponding welded portions. Thus, electric resistance at these terminals can be held low. Such a structure can also be said to be a structure particularly suitable for an electric circuit through which a large current flows.

As an aspect of the present disclosure, the fulcrum portion of the arm spring may be a portion that abuts a protruding portion provided on the laying plate and protruding toward the side wall or a protruding portion provided on the side wall and protruding toward the laying plate.

In the present disclosure, the protruding portion refers to a portion that locally protrudes due to bending or formation of a raised portion when provided on the laying plate. It refers to a portion that locally protrudes due to bending or formation of a raised portion also when provided on the side wall. However, a cross-sectional shape of the portion is not limited to an arc shape.

According to this disclosure, when the protruding portion is provided on the laying plate, the vertex of the protruding portion reliably abuts the side wall. When the protruding portion is provided on the side wall, the vertex of the protruding portion reliably abuts the laying plate. Thus, it is possible to prevent the fulcrum portion from being displaced when the male terminal is inserted into the female terminal.

As an aspect of the present disclosure, the welded portion in at least one side wall of the pair of side walls may form one or a plurality of curved or bent-line-shaped welding patterns.

The curved or bent-line-shaped welding pattern in the present disclosure refers to a pattern having one or more curved points or bending points. However, a specific aspect of the pattern having one or more curved points or bending points is not limited.

According to the present disclosure, since the length of the welding line increases, the strength against a load can improve. In addition, conductivity can improve. Such a structure can also be said to be a structure particularly suitable for an electric circuit through which a large current flows. Further, since the load acts in a distributed manner for each section in the welding line, it is possible to prevent the welded portion from being broken or the like as a whole even when the load concentrates on a specific section and the welded portion is broken or the like. Thus, conductivity can also be stabilized.

As an aspect of the present disclosure, the welded portion in at least one side wall of the pair of side walls may form a welding pattern with an end in which one or a plurality of end portions are widened.

The welding pattern with an end in the present disclosure refers to an open pattern in which a start point and an end point of a welding line are not connected to the same welding line and do not intersect at a middle portion of the welding line. However, a specific aspect of the open pattern is not limited.

According to this disclosure, since the start point and the end point of the welding line are wider than other portions of the welding line, the strength of the start point and the end point against the load can be improved. Thus, it is possible to prevent occurrence of damage such as cracking or peeling at the start point of the welding line. It is also possible to prevent occurrence of damage such as cracking or peeling at the end point of the welding line. Although the start point and the end point are widened, they can be formed in a straight line shape, and thus can be applied to a narrow region of the laying plate.

As an aspect of the present disclosure, the welded portion in at least one side wall of the pair of side walls may form one or a plurality of endless welding patterns.

The endless welding pattern in the present disclosure refers to a totally or partially closed pattern (closed loop pattern) formed by connecting a start point and an end point of a welding line to the same welding line. However, the present disclosure is not limited to a specific aspect of the totally closed pattern and the partially closed pattern.

According to the present disclosure, since the start point and the end point of the welding line do not appear as end portions of the welding line, it is possible to prevent an excessive load (including fatigue due to repeated stress) from acting on these start point and end point. Thus, it is possible to prevent occurrence of damage such as cracking or peeling at the start point of the welding line. It is also possible to prevent occurrence of damage such as cracking or peeling at the end point of the welding line. Since the welding line has a totally or partially closed pattern, the fatigue strength can be improved even against vibration from any direction.

As an aspect of the present disclosure, the welding pattern may be formed by disposing an end point of a continuous welding line at a start point of the welding line.

The continuous welding line in the present disclosure refers to a solid welding line. In the present disclosure, disposing an end point of a continuous welding line at a start point of the welding line means that the coordinates of the start point of the welding line coincide with the coordinates of the end point. However, it is sufficient that the welding line (so-called bead) has a totally or partially closed pattern, and the coordinates are not limited to complete matching.

According to this disclosure, when welding is performed from the start point to the end point of the welding line, the welding machine returns to the same position, and thus, the lead time in the welding process can be shortened. Specifically, the female terminal is sent to the welding machine one after another, and it is necessary to weld the base portion of the female terminal and the spring member sequentially, but the end point of the welding process for one female terminal and the start point of the welding process for the next female terminal are the same, and it is not necessary to move the welding machine, which can shorten the lead time in the welding process.

As an aspect of the present disclosure, the welding pattern may be formed such that a continuous welding line passes through a start point of the welding line, and an end point of the welding line may be disposed in a middle portion of the welding line.

The continuous welding line in the present disclosure also refers to a solid welding line. In the present disclosure, a welding line passing through a start point of the welding line means that the coordinates of the start point of the welding line coincide with the coordinates at one time point in the middle portion, and an end point of the welding line being disposed in a middle portion of the welding line means that the coordinates at one time point in the middle portion of the welding line coincide with the coordinates at the end point. However, as in the above description, the coordinates are not limited to complete matching.

According to the present disclosure, the length of the welding line is relatively shortened while a closed pattern is formed, and thus, the lead time in the welding process can be shortened. Specifically, although it is necessary to move the welding machine at a relatively slow speed from the start point to the end point of the welding line, the length of the welding line is relatively short, and the welding machine can be moved at a relatively fast speed from the end point of the welding process for one female terminal to the start point of the welding process for the next female terminal, which can shorten the lead time in the welding process.

### BRIEF DESCRIPTION OF THE DRAWINGS

FIG. 1 is an overall perspective view illustrating a connector;

FIG. 2 is an exploded perspective view of a female terminal;

FIG. 3 is a perspective view of the female terminal;

FIG. 4 is a side view of the female terminal;

FIG. 5 is a front view of the female terminal;

FIG. 6 is a plan view of the female terminal;

FIG. 7 is a cross-sectional view as viewed from the arrow A-A in FIG. 6;

FIG. 8 includes a cross-sectional view as viewed from the arrow B-B and a cross-sectional view as viewed from the arrow C-C in FIG. 6;

FIG. 9 is an enlarged cross-sectional view of the female terminal;

FIG. 10 is an enlarged cross-sectional view of a state in which a male terminal is inserted inside the female terminal;

FIG. 11 is an assembly explanatory view of the female terminal;

FIG. 12 is a cross-sectional view of a female terminal according to another embodiment;

FIG. 13 is a cross-sectional view of a female terminal according to another embodiment;

FIG. 14 is a cross-sectional view of a female terminal according to another embodiment;

FIG. 15 is a cross-sectional view of a female terminal according to another embodiment;

FIG. 16 is a cross-sectional view of a female terminal according to another embodiment;

FIG. 17 is a cross-sectional view of a female terminal according to another embodiment;

FIG. 18 is a cross-sectional view of a female terminal according to another embodiment;

FIG. 19 is a cross-sectional view of a female terminal according to another embodiment;

FIG. 20 is a cross-sectional view of a female terminal according to another embodiment;

FIG. 21 is a cross-sectional view of a female terminal according to another embodiment;

FIG. 22 is a cross-sectional view of a female terminal according to another embodiment;

FIG. 23 is a cross-sectional view of a female terminal according to another embodiment; and

FIG. 24 is a cross-sectional view of a female terminal according to another embodiment.

### DETAILED DESCRIPTION

An embodiment of the present disclosure will be described in detail with reference to the drawings.

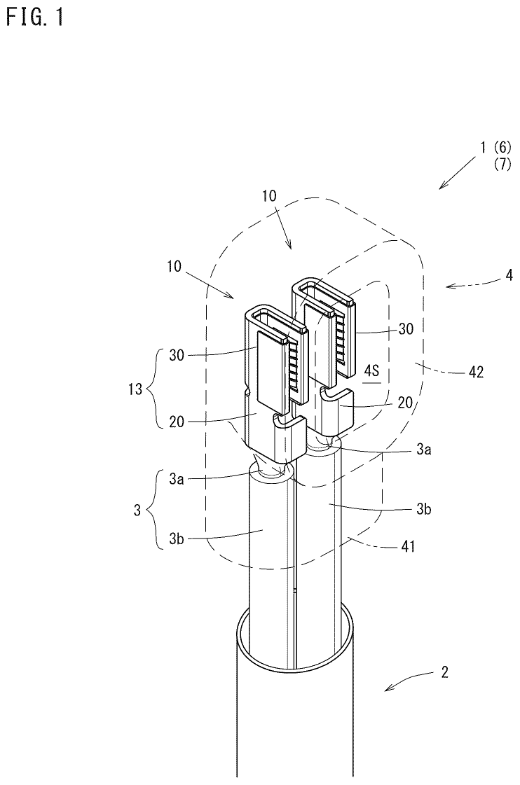

FIG. 1 is an overall perspective view illustrating a connector 1. In FIG. 1, a connector housing 4 that houses a female terminal 10 is indicated by a broken line.

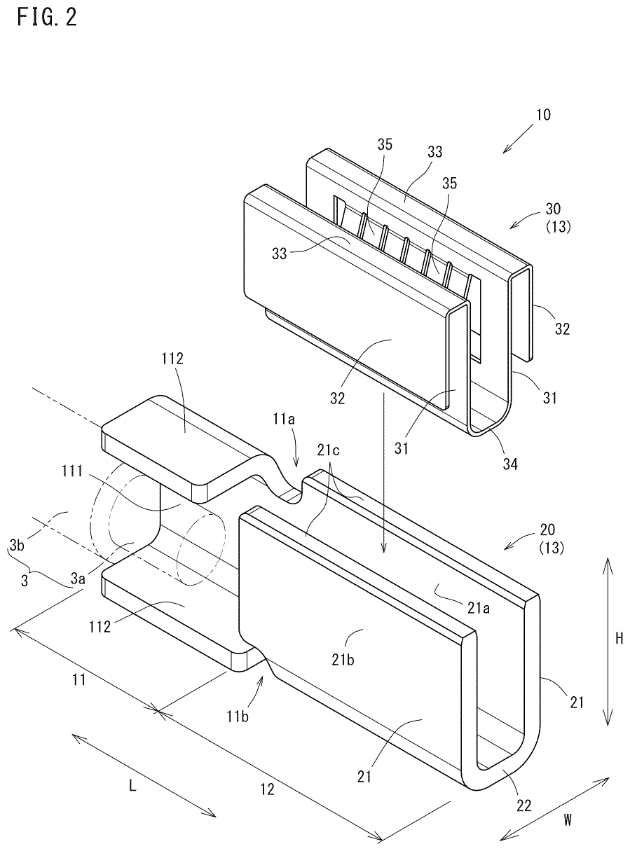

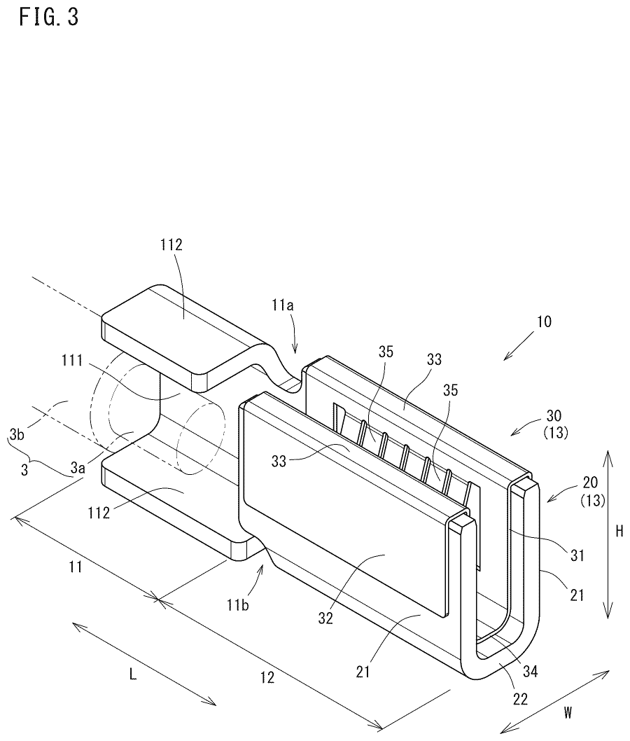

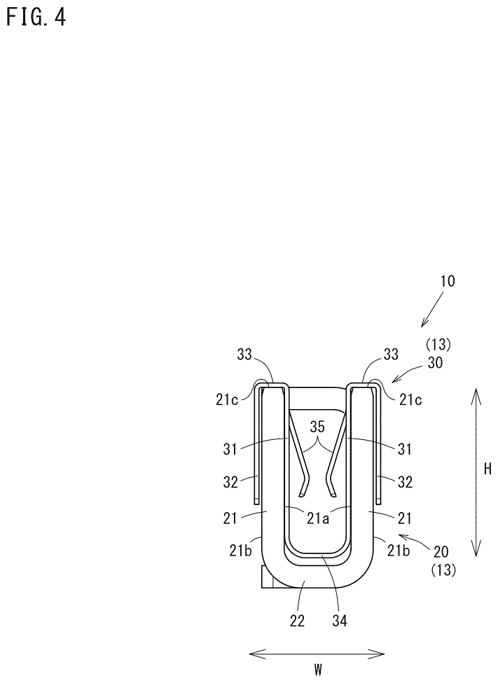

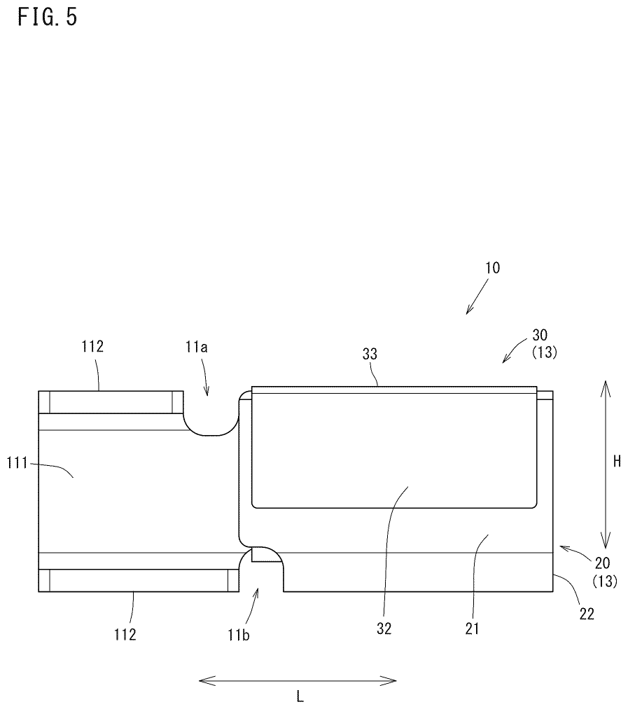

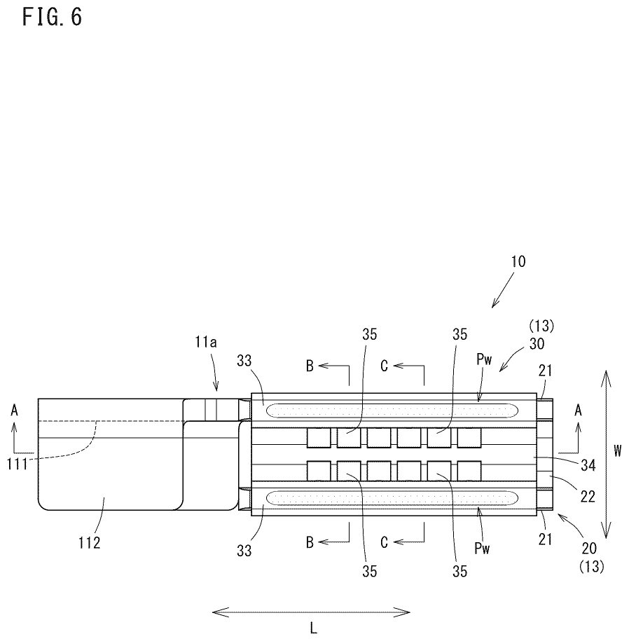

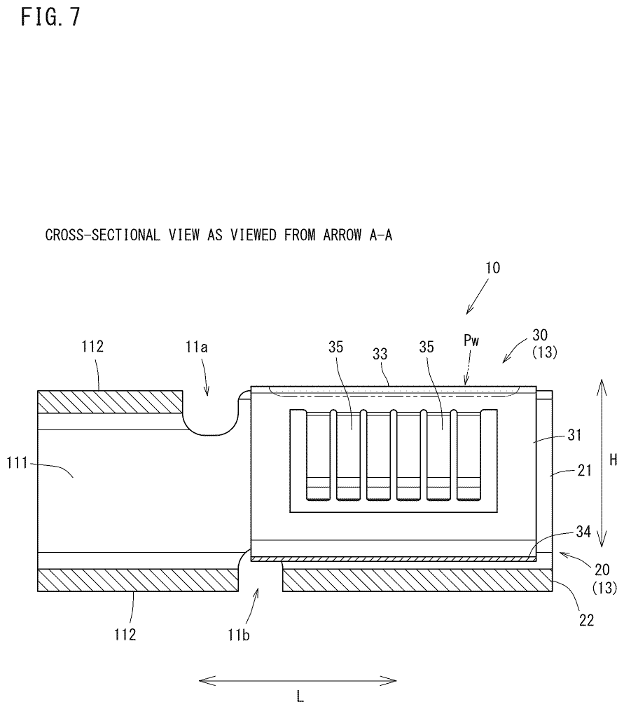

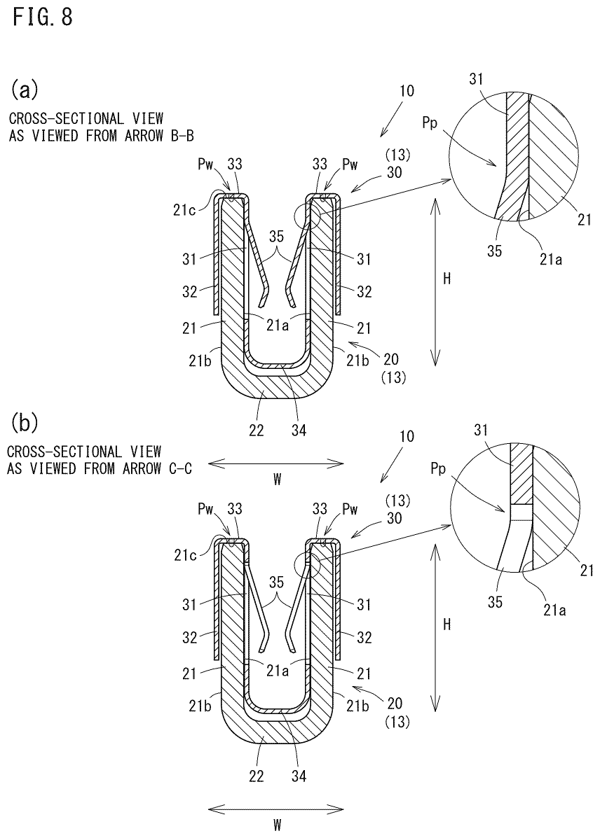

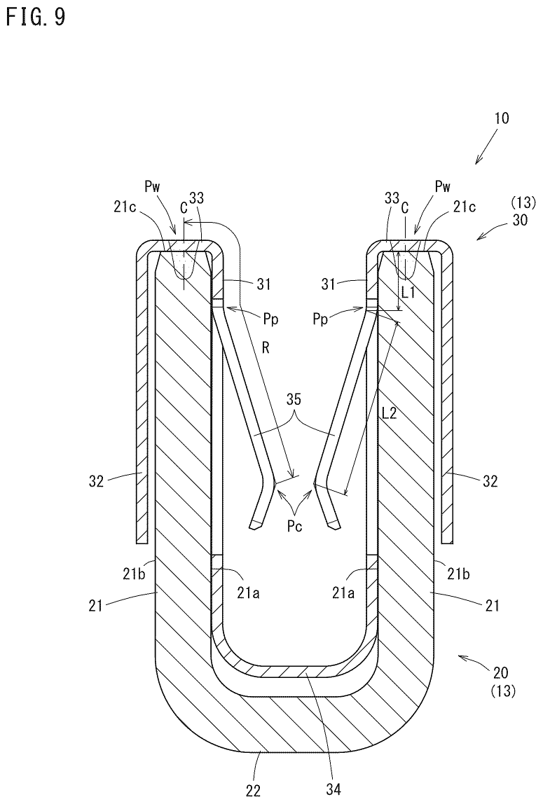

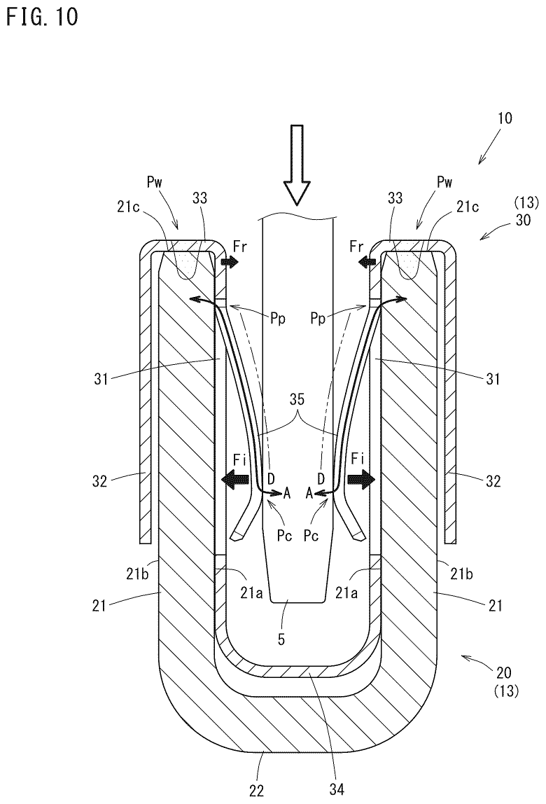

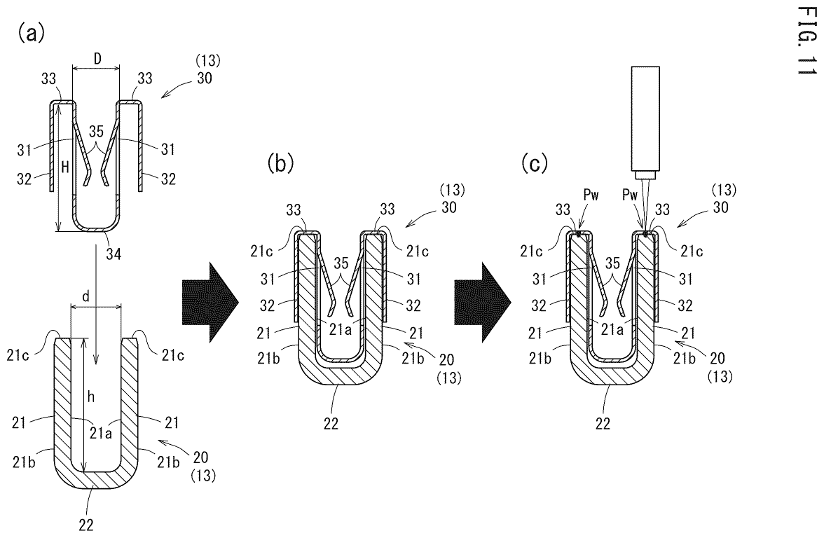

FIG. 2 is an exploded perspective view of the female terminal 10. FIG. 3 is a perspective view of the female terminal 10. FIG. 4 is a side view of the female terminal 10, FIG. 5 is a front view of the female terminal 10, and FIG. 6 is a plan view of the female terminal 10. FIG. 7 is a cross-sectional view as viewed from the arrow A-A in FIG. 6, and FIG. 8 includes a cross-sectional view as viewed from the arrow B-B and a cross-sectional view as viewed from the arrow C-C in FIG. 6. FIG. 9 is an enlarged cross-sectional view of the female terminal 10, and FIG. 10 is an enlarged cross-sectional view of a state in which a male terminal 5 is inserted inside the female terminal 10. FIG. 11 is an assembly explanatory view of the female terminal 10

As illustrated in FIG. 1, the connector 1 is attached to a distal end of an electric wire 3 constituting a wire harness 2. In the connector 1, two female terminals 10 are housed in the connector housing 4 in parallel.

The wire harness 2 is configured by bundling a plurality of electric wires 3. The electric wire 3 is formed by covering a core wire 3a which is an electric conductor with an insulating cover 3b, and the core wire 3a exposed at a distal end of the electric wire 3 is connected to a base portion 20 of the female terminal 10.

The connector housing 4 includes an electric wire insertion portion 41 through which the electric wire 3 is inserted and a terminal housing portion 42 that houses the female terminal 10. A housing space 4S in which the female terminal 10 is housed is open in a substantially quadrangular shape, and a protruding portion of the connector housing that houses the male terminal 5 (see FIG. 9) is fitted into the opening. At this time, the male terminal 5 is inserted into the female terminal 10, and the terminals are electrically connected to each other.

As illustrated in FIGS. 2 to 10, the female terminal 10 includes an electric wire connection portion 11 and a terminal connection portion 12. The electric wire connection portion 11 and the terminal connection portion 12 are provided in series on an extension line of the electric wire 3. In the present application, such a direction will be described as a longitudinal direction L. A direction parallel to the direction in which the male terminal 5 (see FIG. 10) is inserted is referred to as a height direction H, and a direction orthogonal to the longitudinal direction L and the height direction H is referred to as a width direction W.

The electric wire connection portion 11 is provided with a connection plate 111 perpendicular to the width direction W. An upper end and a lower end of the connection plate 111 are bent to provide guide pieces 112. Each of the guide pieces 112 has a role of suppressing expansion of the core wires 3a connected to the connection plate 111.

The terminal connection portion 12 is provided with a terminal body 13 to be electrically connected to the male terminal 5. In the female terminal 10 according to the present embodiment, the terminal body 13 includes a base portion 20 integrally formed including the electric wire connection portion 11 and a spring member 30 to be attached to the base portion 20. Hereinafter, the base portion 20 and the spring member 30 will be described in detail.

The base portion 20 has a pair of side walls 21 disposed at a predetermined interval into which the male terminal 5 can be inserted. More specifically, the base portion 20 has a pair of side walls 21 separated by a predetermined interval perpendicular to the width direction W. The base portion 20 has a bottom wall 22 that connects lower ends of the respective side walls 21. Thus, the base portion 20 has a substantially U shape as viewed in the longitudinal direction L (see FIG. 4)

The side wall 21 on one side of the base portion 20 is formed by extending the connection plate 111 in the longitudinal direction L. The side wall 21 on the other side is formed by folding back a plate material (base material of the base portion 20) to the side where the guide pieces 112 are formed. Thus, the base portion 20 has a substantially rectangular shape as viewed in the height direction H (see FIG. 6). In this manner, the base portion 20 achieves downsizing of the female terminal 10 by forming the side wall 21 on the other side on the side where the guide pieces 112 are formed.

Further, the guide piece 112 on the upper side of the base portion 20 is formed by bending the upper end of the connection plate 111 and is provided with a cutout portion 11a so that the side wall 21 is not distorted when the guide piece 112 is formed. In the same manner, the guide piece 112 on the lower side of the base portion 20 is formed by bending the lower end of the connection plate 111 and is provided with a cutout portion 11b so that the side wall 21 is not distorted when the guide piece 112 is formed. A part of the spring member 30 is exposed at the cutout portion 11b, and the spring member 30 can be pushed out and removed from the lower side (see FIG. 5).

The base portion 20 is formed by being cut out from a plate material having conductivity such as a copper alloy or an aluminum alloy and being bent. The base portion 20 is not plated on its surface, but the base portion 20 is not limited to this configuration. Thus, the surface may be subjected to plating treatment such as silver plating or tin plating for improving conductivity. Alternatively, plating may be partially performed. For example, one in which one surface of the electric wire connection portion 11 or the terminal connection portion 12 is plated can be considered as the base portion in which the plating treatment is partially performed. Alternatively, only the electric wire connection portion 11 may be plated, or only the terminal connection portion 12 may be plated.

The spring member 30 has an inner plate 31 along the inner side surface 21a of the side wall 21 in a state of being fitted between the pair of side walls 21. The spring member 30 also has an outer plate 32 along the outer side surface 21b of the side wall 21. Further, the spring member 30 has a flange plate 33 that connects upper ends of the inner plate 31 and the outer plate 32. The spring member 30 has a bottom plate 34 connecting lower ends of the respective inner plates 31. Thus, the spring member 30 has a substantially M shape as viewed in the longitudinal direction L (see FIG. 4).

The inner plate 31 on one side of the spring member 30 extends in the longitudinal direction L along the opening end edge of the side wall 21, and six arm springs 35 extend from the inner plate 31 toward the opposing side wall 21 (see FIG. 7). All the arm springs 35 have the same shape, and specifically, they extend obliquely downward so as to approach the opposing side wall 21 as viewed in the longitudinal direction L and have a shape in which a part including a distal end edge thereof is folded back (see FIG. 8).

The arm spring 35 provided on the inner plate 31 on one side extends from the lower end edge of the inner plate 31 along the opening end edge of the side wall 21, and a boundary portion with the inner plate 31 serves as a fulcrum portion Pp (see FIG. 8). In the female terminal 10, the fulcrum portion Pp always abuts the inner side surface 21a of the side wall 21. However, the fulcrum portion Pp may abut with deformation when the male terminal 5 is inserted into the female terminal 10.

Further, the inner plate 31 on the other side of the spring member 30 also extends in the longitudinal direction L along the opening end edge of the side wall 21, and six arm springs 35 extend from the inner plate 31 toward the opposing side wall 21 (see FIG. 7). All the arm springs 35 have the same shape, and specifically, they extend obliquely downward so as to approach the opposing side wall 21 as viewed in the longitudinal direction L and have a shape in which a part including a distal end edge thereof is folded back (see FIG. 8).

The arm spring 35 provided on the inner plate 31 on the other side also extends from the lower end edge of the inner plate 31 along the opening end edge of the side wall 21, and a boundary portion with the inner plate 31 serves as a fulcrum portion Pp (see FIG. 8). In the female terminal 10, the fulcrum portion Pp always abuts the inner side surface 21a of the side wall 21. However, the fulcrum portion Pp may abut with deformation when the male terminal 5 is inserted into the female terminal 10.

In addition, in the spring member 30, the flange plate 33 is in surface contact with a distal end surface 21c of the side wall 21. Welding is performed along the longitudinal direction L in the area in surface contact. Thus, a linear welded portion Pw is formed on the flange plate 33 (see FIGS. 6 to 9). The welded portion Pw is a portion where a part of the side wall 21 or the flange plate 33 is melted, cooled, and solidified again. A center line C of the welded portion Pw is perpendicular to the distal end surface 21c of the side wall 21 and the flange plate 33.

Further, in the female terminal 10 according to the present embodiment, the fulcrum portion Pp is provided between the welded portion Pw and a contact portion Pc of the arm spring 35 (see a range R in FIG. 9). Specifically, in a state where the spring member 30 formed by bending the base material is developed in a flat plate shape, the fulcrum portion Pp is provided in the range R sandwiched between the welded portion Pw and the contact portion Pc. According to such a configuration, even when the contact portion Pc is pushed by the insertion of the male terminal 5 (see the arrow Fi in FIG. 10), the fulcrum portion Pp is not displaced in a state of abutting the side wall 21, and thus the arm spring 35 deforms on the contact portion Pc side from the fulcrum portion Pp (see the two dot chain line D in FIG. 10), which suppresses the deformation of the inner plate 31 on the welded portion Pw side from the fulcrum portion Pp.

In addition, in the female terminal 10 according to the present embodiment, a relationship of L1<L2 is preferably established where L1 is a length from the distal end surface 21c of the side wall 21 to the fulcrum portion Pp of the arm spring 35, and L2 is a length from the fulcrum portion Pp of the arm spring 35 to the contact portion Pc. According to such a configuration, when a load (see the arrow Fi in FIG. 10) is applied to the contact portion Pc of the arm spring 35, a rotational force about the fulcrum portion Pp is generated, and even when a load (see the arrow Fr in FIG. 10) that rises from the inner side surface 21a acts on the inner plate 31 closer to the welded portion Pw than the fulcrum portion Pp, the load does not affect the flange plate 33 perpendicular to the inner plate 31. That is, it is considered that the flange plate 33 does not deform to rise from the distal end surface 21c.

In addition, in the female terminal 10 according to the present embodiment, the fulcrum portion Pp serves a function of electrically connecting the arm spring 35 and the side wall 21 Thus, when a current flows from the male terminal 5 to the female terminal 10, the current flows from the contact portion Pc abutting the male terminal 5 to the side wall 21 via the arm spring 35 and through the fulcrum portion Pp (see the arrows A in FIG. 10). When a current flows from the female terminal 10 to the male terminal 5, the current flows from the fulcrum portion Pp abutting the side wall 21 to the male terminal 5 via the arm spring 35 and through the contact portion Pc (see the arrows A in FIG. 10). In this regard, even when the conductivity at the fulcrum portion Pp is low, a current flows through the welded portion Pw close to the fulcrum portion Pp.

The female terminal 10 is assembled as follows. That is, as illustrated in FIG. 11, the spring member 30 is disposed on the upper side of the base portion 20, the inner plate 31 and the bottom plate 34 are fitted between the pair of side walls 21, and welding is performed to assemble the female terminal 10 in a state where the flange plate 33 is brought into surface contact with the distal end surface 21c of the side wall 21. The female terminal 10 is configured such that a relationship of d≤D is established where d is a width dimension from the opening end edge of the side wall 21 on one side to the opening end edge of the side wall 21 on the other side, and D is a width dimension from the opening end edge of the inner plate 31 on one side to the opening end edge of the inner plate 31 on the other side. In addition, the female terminal 10 is configured such that a relationship of h≥H is established where h is a height dimension from the inner side surface of the bottom wall 22 to the distal end surface 21c of the side wall 21, and H is a height dimension from the bottom plate 34 to the flange plate 33. Thus, backlash of the spring member 30 can be suppressed, a wide contact area can be secured, and the flange plate 33 can be reliably brought into surface contact with the distal end surface 21c of the side wall 21.

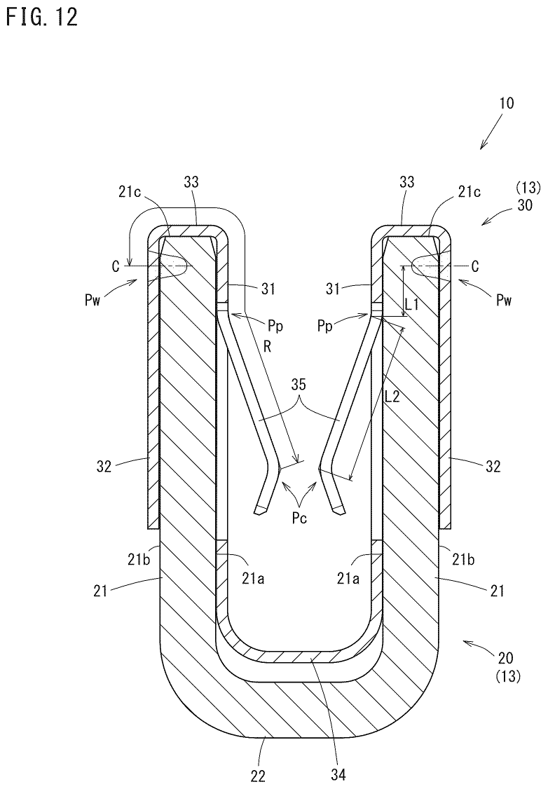

Next, the female terminal 10 according to another embodiment will be described with reference to FIG. 12. In the female terminal 10, the outer plate 32 is welded to the outer side surface 21b of the side wall 21. The fulcrum portion Pp is provided between the welded portion Pw and the contact portion Pc of the arm spring 35 (see the range R in FIG. 12). Further, it is preferable that a relationship of L1<L2 is established where L1 is a length from the center line C of the welded portion Pw to the fulcrum portion Pp of the arm spring 35, and L2 is a length from the fulcrum portion Pp of the arm spring 35 to the contact portion Pc.

According to such a female terminal 10, a rotational force about the fulcrum portion Pp is generated by applying a load to the contact portion Pc of the arm spring 35, and even when a load that rises from the inner side surface 21a acts on the inner plate 31 closer to the welded portion Pw than the fulcrum portion Pp, the load does not affect the outer plate 32 parallel to the inner plate 31. That is, it is considered that the outer plate 32 does not deform to rise from the outer side surface 21b.

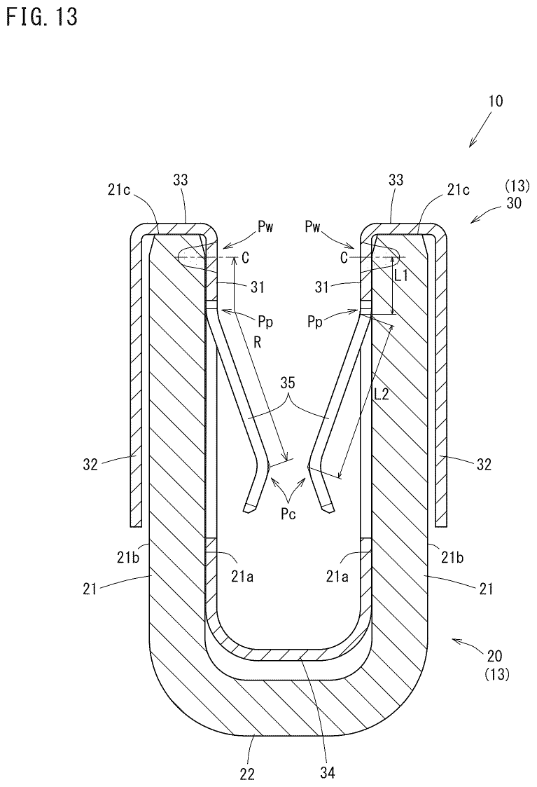

Next, the female terminal 10 according to another embodiment will be described with reference to FIG. 13. In the female terminal 10, the inner plate 31 is welded to the inner side surface 21a of the side wall 21. The fulcrum portion Pp is provided between the welded portion Pw and the contact portion Pc of the arm spring 35 (see the range R in FIG. 13). Further, it is preferable that a relationship of L1<L2 is established where L1 is a length from the center line C of the welded portion Pw to the fulcrum portion Pp of the arm spring 35, and L2 is a length from the fulcrum portion Pp of the arm spring 35 to the contact portion Pc.

According to such a female terminal 10, a rotational force about the fulcrum portion Pp is generated by applying a load to the contact portion Pc of the arm spring 35, and even when a load that rises from the inner side surface 21a acts on the inner plate 31 closer to the welded portion Pw than the fulcrum portion Pp, deformation of the inner plate 31 can be suppressed by devising a welding more. For example, in the inner plate 31 along each of the pair of side walls 21, it is considered that deformation of the inner plate 31 can be suppressed by configuring each welded portion Pw with a plurality of welded portions Pw or a plurality of welded points.

In this manner, in the female terminal 10 according to the present embodiment, the terminal body 13 is provided by the base portion 20 to be connected to the electric wire 3 and the spring member 30 to be attached to the base portion 20. The base portion 20 has the pair of side walls 21 disposed at a predetermined interval into which the male terminal 5 can be inserted, the spring member 30 has the laying plate (inner plate 31) along the inner side surface 21a of the side wall 21 and the arm spring 35 extending from the laying plate (inner plate 31) toward the opposing side wall 21, and the side wall 21 and the laying plate (for example, the flange plate 33) are welded to form the welded portion Pw. The present embodiment is characterized in that the fulcrum portion Pp of the arm spring 35 abutting the side wall 21 is provided between the welded portion Pw and the contact portion Pc of the arm spring 35.

According to such a female terminal 10, it is possible to prevent an excessive load from acting on the welded portion Pw between the base portion 20 and the spring member 30.

More specifically, in the female terminal 10 according to the present disclosure, the fulcrum portion Pp of the arm spring 35 abutting the side wall 21 is provided between the welded portion Pw and the contact portion Pc of the arm spring 35. According to such a configuration, even when the contact portion Pc is pushed by the insertion of the male terminal 5 (see the arrow Fi in FIG. 10), the fulcrum portion Pp is not displaced in a state of abutting the side wall 21, and thus the arm spring 35 deforms on the contact portion Pc side from the fulcrum portion Pp (see the two dot chain line D in FIG. 10), which suppresses the deformation of the inner plate 31 on the welded portion Pw side from the fulcrum portion Pp. Thus, it is possible to prevent an excessive load from acting on the welded portion Pw between the side wall 21 and the flange plate 33. In other words, it is possible to prevent an excessive load from acting on the welded portion Pw between the base portion 20 and the spring member 30.

In addition, since the fulcrum portion Pp reliably abuts the side wall 21 of the base portion 20, a current flows through a short path. That is, when a current flows from the male terminal 5 to the female terminal 10, the current flows from the contact portion Pc abutting the male terminal 5 to the side wall 21 via the arm spring 35 and through the fulcrum portion Pp (see the arrows A in FIG. 10). When a current flows from the female terminal 10 to the male terminal 5, the current flows from the fulcrum portion Pp abutting the side wall 21 to the male terminal 5 via the arm spring 35 and through the contact portion Pc (see the arrows A in FIG. 10). Thus, electric resistance at these terminals can be held low. Such a structure can be said to be a structure particularly suitable for an electric circuit through which a large current flows.

In the female terminal 10 according to the first embodiment, the flange plate 33 is provided along the distal end surface 21c of the side wall 21, and the flange plate 33 is welded to the distal end surface 21c of the side wall 21. The distal end surface 21c is a surface of at least one side wall 21 of the pair of side walls 21 intersecting the insertion direction of the male terminal 5.

According to such a female terminal 10, even when the contact portion Pc is pushed by the insertion of the male terminal 5, the fulcrum portion Pp is not displaced in a state of abutting the side wall 21, and thus the arm spring 35 deforms on the contact portion Pc side from the fulcrum portion Pp, which suppresses the deformation of the inner plate 31 on the welded portion Pw side of the fulcrum portion Pp. In addition, even when a load acts on the inner side surface 21a of the side wall 21 due to the moment about the fulcrum portion Pp, the load does not affect the flange plate 33 along the distal end surface 21c of the side wall 21. Thus, it is possible to prevent an excessive load from acting on the welded portion between the side wall 21 and the flange plate 33. In other words, it is possible to prevent an excessive load from acting on the welded portion Pw between the base portion 20 and the spring member 30.

In addition, even when the conductivity at the fulcrum portion Pp is low, a current flows through a relatively short path. That is, when a current flows from the male terminal 5 to the female terminal 10, the current flows from the contact portion Pc abutting the male terminal 5 to the side wall 21 via the arm spring 35, not through the fulcrum portion Pp but through the welded portion Pw formed on the flange plate 33 along the distal end surface 21c of the side wall 21. On the other hand, when a current flows from the female terminal 10 to the male terminal 5, the current flows not from the fulcrum portion Pp abutting the side wall 21 but from the welded portion Pw formed on the flange plate 33 along the distal end surface 21c of the side wall 21 to the male terminal 5 via the arm spring 35 and through the contact portion Pc. Thus, electric resistance at these terminals can be held low. Such a structure can also be said to be a structure particularly suitable for an electric circuit through which a large current flows.

In addition, since the distal end surface 21c of the side wall 21 and the flange plate 33 along the distal end surface 21c are surfaces intersecting with the insertion direction of the male terminal 5, the welding machine that performs these welding can freely approach and move. Thus, such a welding step can be easily realized. In this regard, the portion where the flange plate 33 overlaps the distal end surface 21c of the side wall 21 has a shape having a narrow width and a long length, and thus it is preferable to perform linear or dotted welding.

In the female terminal 10 according to the second embodiment, the outer plate 32 is provided with respect to the outer side surface 21b of the side wall 21, and the outer plate 32 is welded to the outer side surface 21b of the side wall 21. The outer side surface 21b is a surface of at least one side wall 21 of the pair of side walls 21, the surface being on the opposite side of the surface facing a side surface of the male terminal 5.

According to such a female terminal 10, even when the contact portion Pc is pushed by the insertion of the male terminal 5, the fulcrum portion Pp is not displaced in a state of abutting the side wall 21, and thus the arm spring 35 deforms on the contact portion Pc side from the fulcrum portion Pp, which suppresses the deformation of the inner plate 31 on the welded portion Pw side of the fulcrum portion Pp. In addition, even when a load acts on the inner side surface 21a of the side wall 21 due to the moment about the fulcrum portion Pp, the load does not affect the outer plate 32 along the outer side surface 21b of the side wall 21. Thus, it is possible to prevent an excessive load from acting on the welded portion Pw between the side wall 21 and the outer plate 32. In other words, it is possible to prevent an excessive load from acting on the welded portion Pw between the base portion 20 and the spring member 30.

In addition, even when the conductivity at the fulcrum portion Pp is low, a current flows through a relatively short path. That is, when a current flows from the male terminal 5 to the female terminal 10, the current flows from the contact portion Pc abutting the male terminal 5 to the side wall 21 via the arm spring 35, not through the fulcrum portion Pp but through the welded portion Pw formed on the outer plate 32 along the outer side surface 21b of the side wall 21. When a current flows from the female terminal 10 to the male terminal 5, the current flows not from the fulcrum portion Pp abutting the side wall 21 but from the welded portion Pw formed on the outer plate 32 along the outer side surface 21b of the side wall 21 to the male terminal 5 via the arm spring 35 and through the contact portion Pc. Thus, electric resistance at these terminals can be held low. Such a structure can also be said to be a structure particularly suitable for an electric circuit through which a large current flows.

In addition, since the outer side surface 21b of the side wall 21 and the outer plate 32 along the outer side surface 21b are surfaces on the opposite side of the surface facing a side surface of the inserted male terminal 5, the welding machine that performs these welding can freely approach and move. Thus, such a welding step can be easily realized. In this regard, the portion where the outer plate 32 overlaps with respect to the outer side surface 21b of the side wall 21 has a shape having a wide width and a long length, and thus any welding mode can be applied.

In the female terminal 10 according to a third embodiment, the inner plate 31 is provided along the inner side surface 21a of the side wall 21, and the inner plate 31 is welded to the inner side surface 21a of the side wall 21. The inner side surface 21a is a surface of at least one side wall 21 of the pair of side walls 21 facing the side surface of the male terminal 5.

According to such a female terminal 10, even when the contact portion Pc is pushed by the insertion of the male terminal 5, the fulcrum portion Pp is not displaced in a state of abutting the side wall 21, and thus the arm spring 35 deforms on the contact portion Pc side from the fulcrum portion Pp, which suppresses the deformation of the inner plate 31 on the welded portion Pw side of the fulcrum portion Pp. In addition, since the inner plate 31 is welded to the inner side surface 21a of the side wall 21, deformation of the inner plate 31 can be suppressed by devising a welding mode. Thus, it is possible to prevent an excessive load from acting on the welded portion Pw between the side wall 21 and the inner plate 31. In other words, it is possible to prevent an excessive load from acting on the welded portion Pw between the base portion 20 and the spring member 30.

In addition, even when the conductivity at the fulcrum portion Pp is low, a current flows through a relatively short path. That is, when a current flows from the male terminal 5 to the female terminal 10, the current flows from the contact portion Pc abutting the male terminal 5 to the side wall 21 via the arm spring 35, not through the fulcrum portion Pp but through the welded portion Pw formed on the inner plate 31 along the inner side surface 21a of the side wall 21. On the other hand, when a current flows from the female terminal 10 to the male terminal 5, the current flows not from the fulcrum portion Pp abutting the side wall 21 but from the welded portion Pw formed on the inner plate 31 along the inner side surface 21a of the side wall 21 to the male terminal 5 via the arm spring 35 and through the contact portion Pc. Thus, electric resistance at these terminals can be held low. Such a structure can also be said to be a structure particularly suitable for an electric circuit through which a large current flows.

In the female terminal 10 according to each embodiment, the side wall 21 and the laying plate (inner plate 31, outer plate 32, and flange plate 33) are welded using a fiber laser welding machine, but welding may be performed by using an arc welding machine or the like. Welding may also be performed by using a welding machine capable of ultrasonic welding, resistance welding, friction welding, or other welding. Further, braze welding such as brazing and soldering is also included in the concept of welding.

In the correspondence between the configuration of the present disclosure and the foregoing embodiments, the connector of the present disclosure corresponds to the connector 1, and
in the same manner,
the wire harness corresponds to the wire harness 2,
the electric wire corresponds to the electric wire 3,
the connector housing corresponds to the connector housing 4,
the male terminal corresponds to the male terminal 5,
the female terminal corresponds to the female terminal 10,
the terminal body corresponds to the terminal body 13,
the base portion corresponds to the base portion 20,
the side wall corresponds to the side wall 21,
the inner side surface corresponds to the inner side surface 21a,
the outer side surface corresponds to the outer side surface 21b,
the distal end surface corresponds to the distal end surface 21c,
the spring member corresponds to the spring member 30,
the laying plate corresponds to the inner plate 31, the outer plate 32, and the flange plate 33,
the arm spring corresponds to the arm spring 35,
the welded portion corresponds to the welded portion Pw,
the contact portion corresponds to the contact portion Pc, and
the fulcrum portion corresponds to the fulcrum portion Pp. However, the present disclosure is not limited to the configuration of the foregoing embodiments, and many embodiments can be obtained.

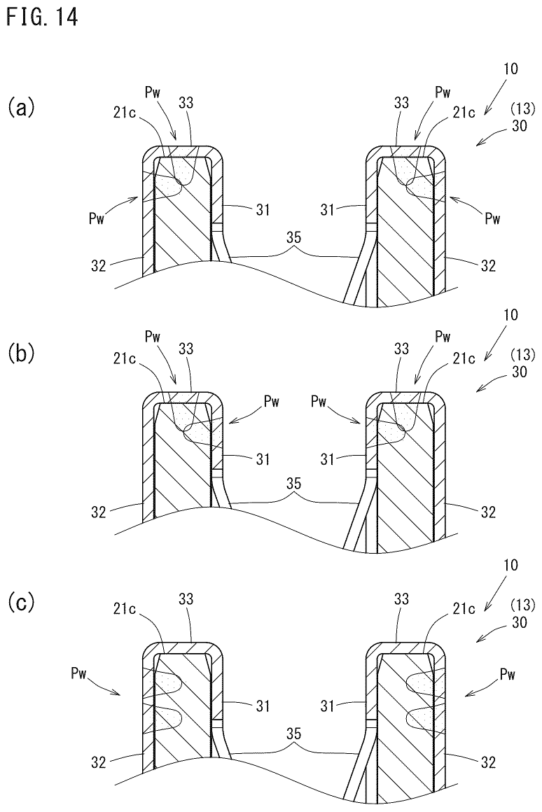

For example, in the female terminal 10 according to the first embodiment, the flange plate 33 is welded to the distal end surface 21c of the side wall 21, in the female terminal 10 according to the second embodiment, the outer plate 32 is welded to the outer side surface 21b of the side wall 21, and in the female terminal 10 according to the third embodiment, the inner plate 31 is welded to the inner side surface 21a of the side wall 21. However, as illustrated in FIG. 14(a), welding on the flange plate 33 and welding on the outer plate 32 may be performed. Alternatively, as illustrated in FIG. 14(b), welding on the flange plate 33 and welding on the inner plate 31 may be performed. Of course, as illustrated in FIG. 14(c), in the outer plate 32 along each of the pair of side walls 21, each welded portion Pw may be configured by a plurality of welded portions Pw or a plurality of welded points. The same applies to the welded portions Pw of the inner plate 31 and the flange plate 33.

Having such a configuration can prevent a load from concentrating on a specific welded portion Pw. In addition, even when a load is concentrated on a specific welded portion Pw and the welded portion Pw is broken or the like, it is possible to prevent the welded portion Pw from being broken or the like as a whole. Thus, conductivity can be stabilized. Further, a parallel circuit is configured locally because a current flows through corresponding welded portions Pw. Thus, electric resistance at these terminals can be held low. Such a structure can also be said to be a structure particularly suitable for an electric circuit through which a large current flows.

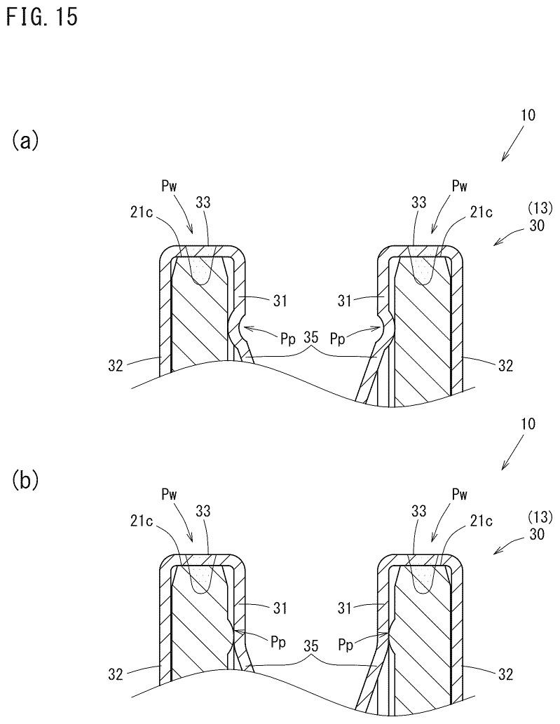

Further, in the female terminal 10 according to each of the embodiments, the arm spring 35 extends from the lower end edge of the inner plate 31 along the opening end edge of the side wall 21, and a boundary portion with the inner plate 31 serves as the fulcrum portion Pp. However, as illustrated in FIG. 15(a), a protruding portion may be provided on the inner plate 31, and the vertex thereof may abut the side wall 21. Alternatively, as illustrated in FIG. 15(b), a protruding portion may be provided on the side wall 21, and the vertex thereof may abut the inner plate 31.

With such a configuration, when the protruding portion is provided on the inner plate 31, the vertex of the protruding portion reliably abuts the side wall 21. On the other hand, when the protruding portion is provided on the side wall 21, the vertex of the protruding portion reliably abuts the inner plate 31. Thus, it is possible to prevent the fulcrum portion Pp from being displaced when the male terminal 5 is inserted into the female terminal 10.

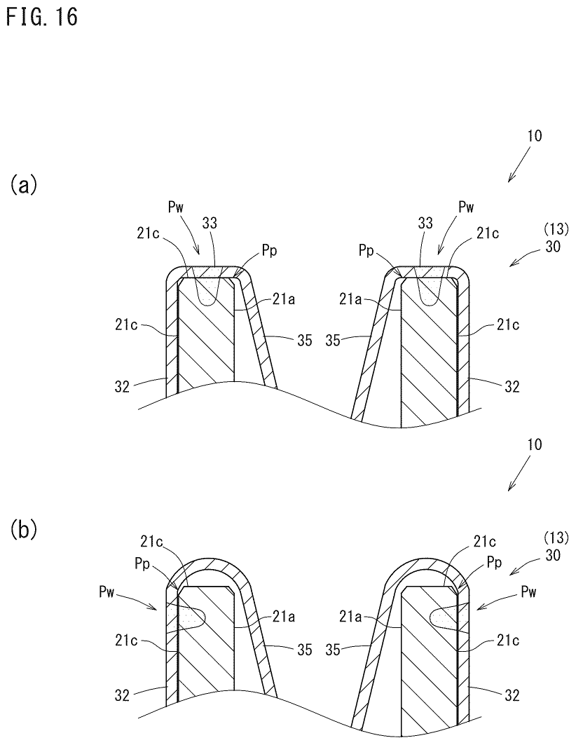

In addition, in the female terminal 10 according to each of the embodiments, the fulcrum portion Pp of the arm spring 35 is provided on the inner plate 31 along the inner side surface 21a of the side wall 21. However, as illustrated in FIG. 16(a), on the premise that the welded portion Pw is formed on the outer plate 32 or the flange plate 33, the fulcrum portion Pp may be provided at a bent portion that goes around a corner portion between the inner side surface 21a and the distal end surface 21c of the side wall 21. Alternatively, as illustrated in FIG. 16(b), on the premise that the welded portion Pw is formed on the outer plate 32, the fulcrum portion Pp may be provided at a bent portion that goes around a corner portion between the outer side surface 21b and the distal end surface 21c of the side wall 21.

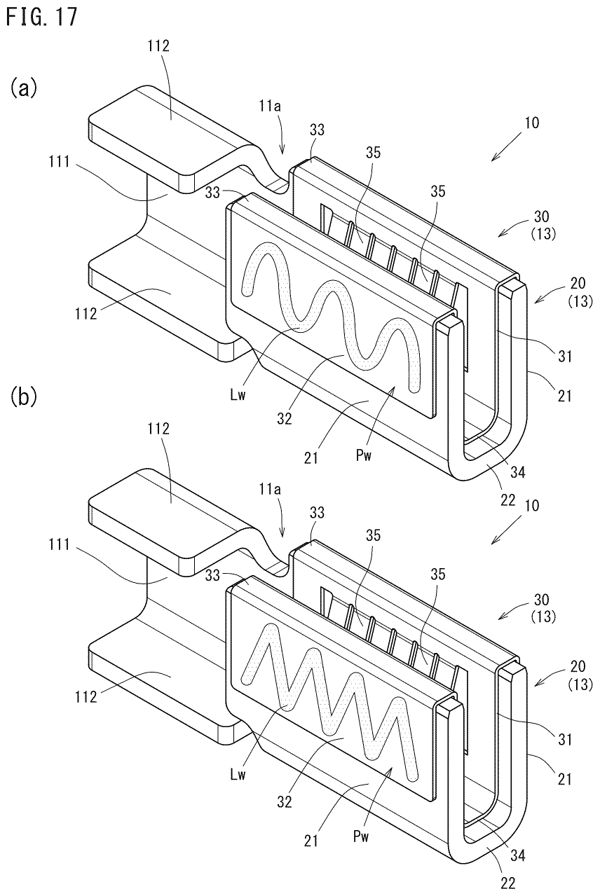

In addition, in the female terminal 10 according to each of the embodiments, the welded portion Pw may form one or a plurality of curved or bent-line-shaped welding patterns. For example, as illustrated in FIG. 17(a), the welded portion Pw of the outer plate 32 may form a curved welding pattern. Alternatively, as illustrated in FIG. 17(b), the welded portion Pw of the outer plate 32 may form a bent-line-shaped welding pattern.

With such a configuration, since the length of the welding line Lw becomes long, the strength against the load can be improved. In addition, conductivity can improve. Such a structure can also be said to be a structure particularly suitable for an electric circuit through which a large current flows. Further, since the load acts in a distributed manner for each section in the welding line Lw, it is possible to prevent the welded portion Pw from being broken or the like as a whole even when the load concentrates on a specific section and the welded portion Pw is broken or the like. Thus, conductivity can also be stabilized.

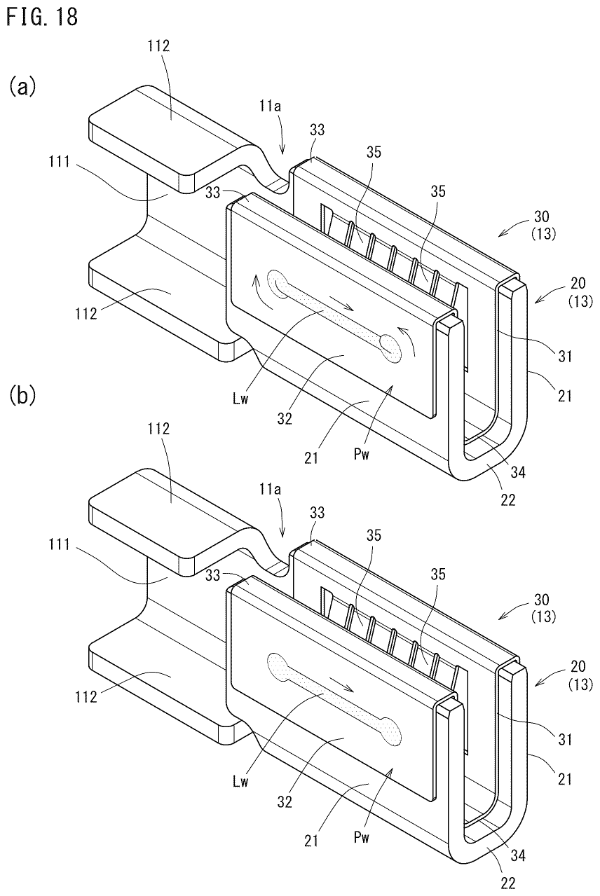

In addition, in the female terminal 10 according to each of the embodiments, the welded portion Pw may form a welding pattern with an end in which one or a plurality of end portions are widened. For example, as illustrated in FIG. 18(a), both end portions may be formed in a widened shape by drawing a circle or the like (including a simple folding or wavy shape) at the start point Ps and the end point Pe. Alternatively, as illustrated in FIG. 18(b), both end portions may have a widened shape by widening the laser focus or adjusting the speed at the start point Ps and the end point Pe. In each drawing, the directions in which the welding machine moves are indicated by arrows.

With such a configuration, since the start point Ps and the end point Pe of the welding line Lw are wider than other portions of the welding line Lw, the strength of the start point Ps and the end point Pe against the load can be improved. Thus, it is possible to prevent occurrence of damage such as cracking or peeling at the start point Ps of the welding line Lw. It is also possible to prevent occurrence of damage such as cracking or peeling at the end point Pe of the welding line Lw. Although the start point Ps and the end point Pe are widened, they can be formed in a straight line shape, and thus can be applied to a narrow region of the laying plate (flange plate 33).

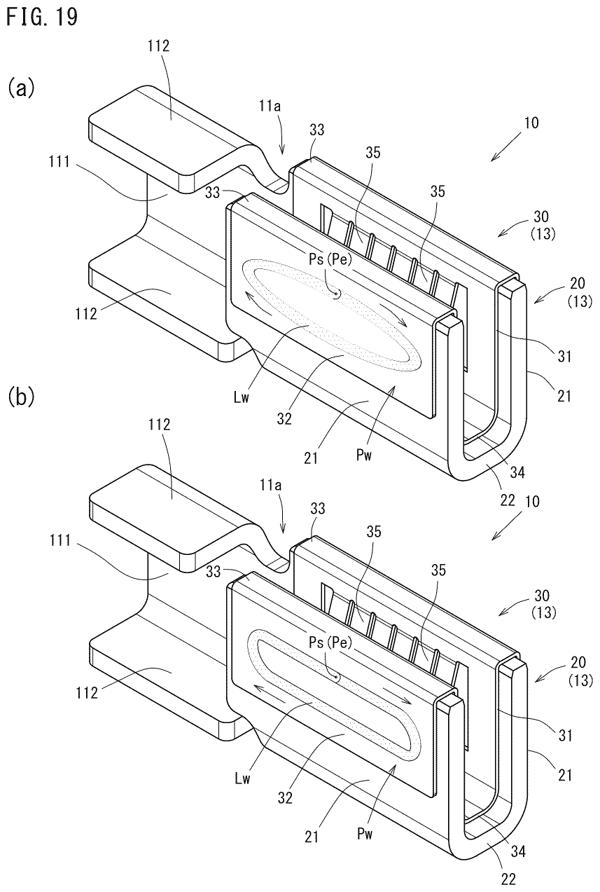

In the female terminal 10 according to each of the embodiments, the welded portion Pw may form one or a plurality of endless welding patterns. That is, as illustrated in FIGS. 19(a) to 24(a), the pattern is a totally or partially closed pattern (closed loop pattern) in which the start point Ps and the end point Pe of the welding line Lw are connected to the same welding line Lw. In each drawing, the directions in which the welding machine moves are indicated by arrows. In addition, all or a part of the welded portion Pw and the welding line Lw may be formed by so-called wobbling welding in which scanning is performed while drawing a fine pattern such as a circle or a line.

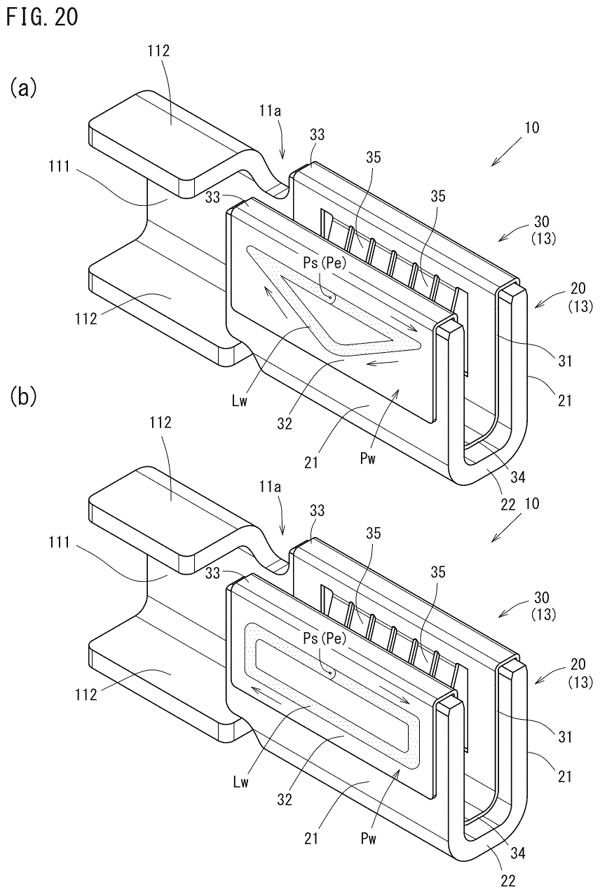

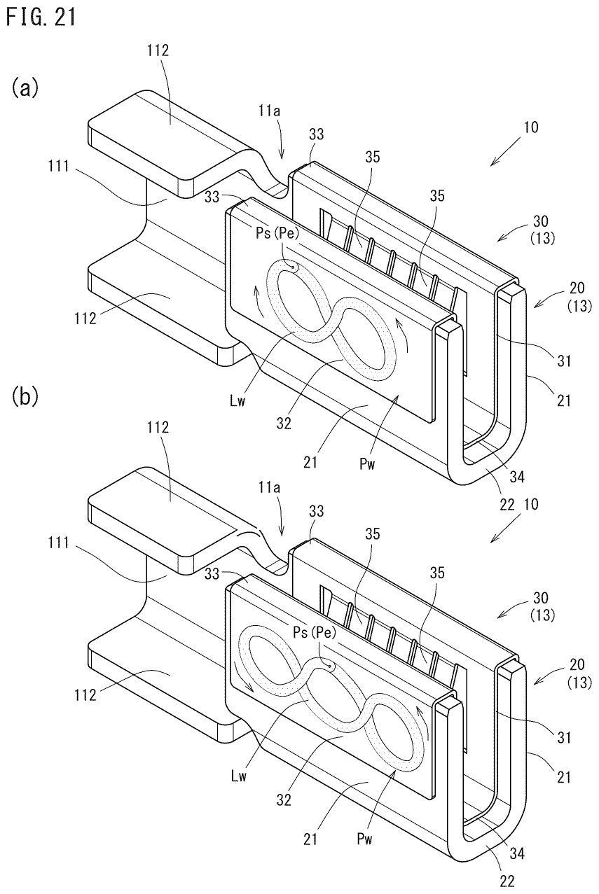

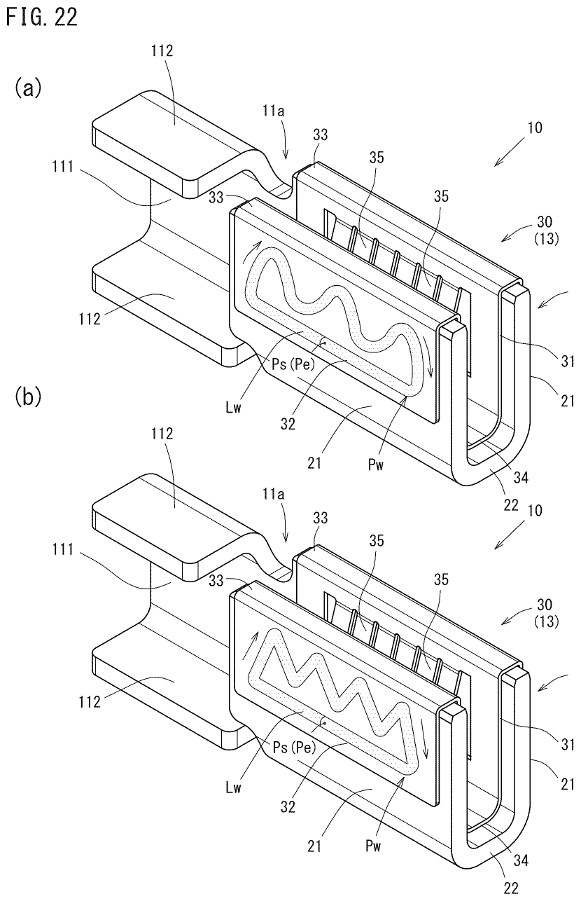

Specifically, as illustrated in FIGS. 19(a) and (b), the welding line Lw may have an elliptical shape or an oval shape. As illustrated in FIGS. 20(a) and (b), a shape having a triangle, a square, or more corners may also be adopted. As illustrated in FIGS. 21 (a) and (b), a shape in which the letter “8” is connected once, twice, or more times may also be adopted. As illustrated in FIGS. 22(a) and (b), a shape in which a curved line or a folding line is drawn, and both end portions is connected to each other may also be adopted.

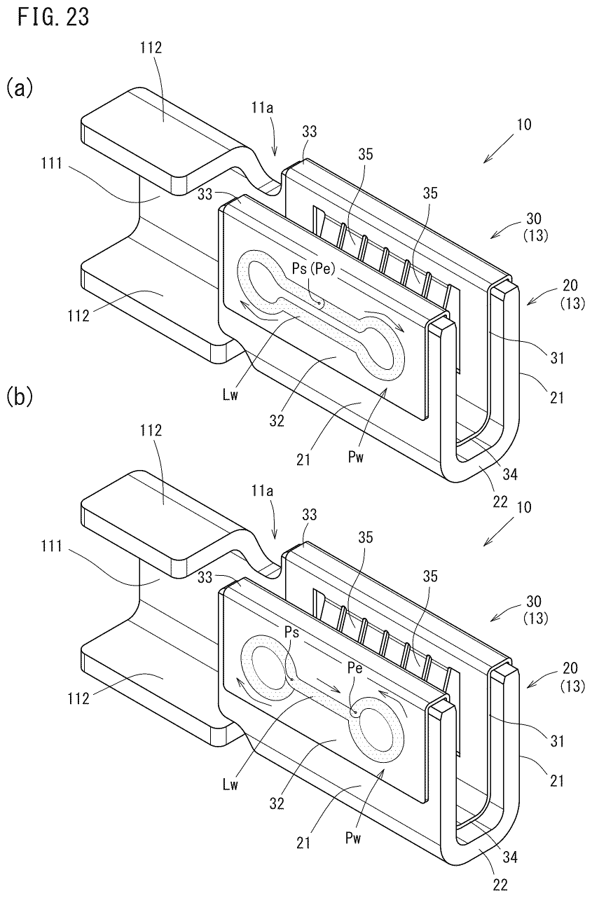

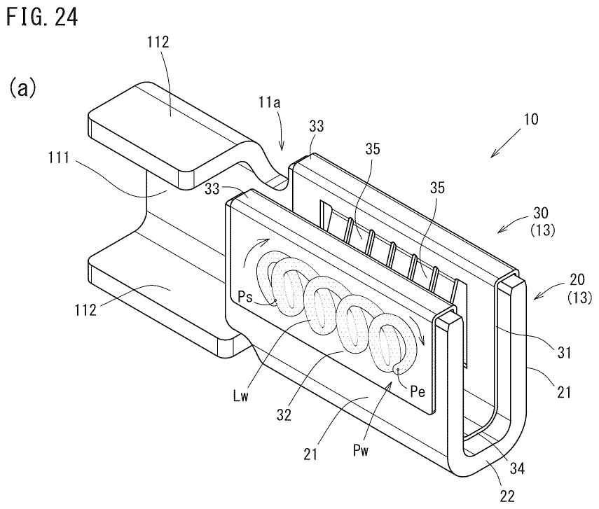

Further, as illustrated in FIG. 23(a), a shape in which the long side portions of an elliptical shape is brought close to each other may be adopted, or as illustrated in FIG. 23(b), a shape in which a circle or the like (including an elliptical shape, a polygonal shape, or the like) is drawn at the start point Ps and the end point Pe to connect both end portions to a middle portion of the welding line Lw may be adopted. Further, as illustrated in FIG. 24(a), a shape in which both end portions is connected to a middle portion of the welding line Lw by continuously drawing a circle or the like (including an elliptical shape, a polygonal shape, or the like) while moving to one side may be adopted.

With such a configuration, since the start point Ps and the end point Pe of the welding line Lw do not appear as end portions of the welding line Lw, it is possible to prevent an excessive load (including fatigue due to repeated stress) from acting on these start point Ps and end point Pe. Thus, it is possible to prevent occurrence of damage such as cracking or peeling at the start point Ps of the welding line Lw. It is also possible to prevent occurrence of damage such as cracking or peeling at the end point Pe of the welding line Lw. Since the welding line Lw has a totally or partially closed pattern, the fatigue strength can be improved even against vibration from any direction.

The welding pattern illustrated in FIGS. 19(a) to 23(a) is formed such that the end point Pe of the continuous welding line Lw is disposed at the start point Ps of the welding line Lw. Thus, the coordinates of the start point Ps and the coordinates of the end point Pe of the welding line Lw coincide with each other.

With such a configuration, when welding is performed from the start point Ps to the end point Pe of the welding line Lw, the welding machine returns to the same position, and thus, the lead time in the welding process can be shortened. Specifically, the female terminal 10 is sent to the welding machine one after another, and it is necessary to weld the base portion 20 of the female terminal 10 and the spring member 30 sequentially, but the end point Pe of the welding process for one female terminal 10 and the start point Ps of the welding process for the next female terminal 10 are the same, and it is not necessary to move the welding machine, which can shorten the lead time in the welding process.

On the other hand, in the welding pattern illustrated in FIGS. 23(b) to 24(a), the continuous welding line Lw passes through the start point Ps of the welding line Lw, and the end point Pe of the welding line Lw is disposed in a middle portion of the welding line Lw. Thus, the coordinates of the start point Ps of the welding line Lw and the coordinates of the middle portion at one time point coincide with each other, and the coordinates of the middle portion at one time point coincide with the coordinates of the end point Pe.

With such a configuration, the length of the welding line Lw is relatively shortened while a closed pattern is formed, and thus, the lead time in the welding process can be shortened. Specifically, although it is necessary to move the welding machine at a relatively slow speed from the start point Ps to the end point Pe of the welding line Lw, the length of the welding line Lw is relatively short, and the welding machine can be moved at a relatively fast speed from the end point Pe of the welding process for one female terminal 10 to the start point Ps of the welding process for the next female terminal 10, which can shorten the lead time in the welding process.

Finally, the disclosure of the present application includes the connector 1 (see FIG. 1) provided with the female terminal 10 and the connector housing 4 that houses the female terminal 10, and the terminal-attached electric wire 6 (see FIG. 1) provided with the female terminal 10 and the electric wire 3 connected to the base portion 20 of the female terminal 10.

Further, the disclosure of the present application includes the connector-attached electric wire 7 (see FIG. 1) provided with the terminal-attached electric wire 6 and the connector housing 4 that houses the terminal-attached electric wire 6, and the wire harness 2 (see FIG. 1) provided with at least one of the terminal-attached electric wire 6 and the connector-attached electric wire 7.

These also exert the same effects as those of the female terminal 10 according to the present disclosure. That is, since the fulcrum portion Pp of the arm spring 35 abutting the side wall 21 is provided between the welded portion Pw and the contact portion Pc of the arm spring 35, it is possible to prevent an excessive load from acting on the welded portion Pw between the base portion 20 and the spring member 30.

### REFERENCE SIGNS LIST

1 connector
2 wire harness
3 electric wire
4 connector housing
5 male terminal
6 terminal-attached electric wire
7 connector-attached electric wire
10 female terminal
13 terminal body
20 base portion
21 side wall
21a inner side surface
21b outer side surface
21c distal end surface
30 spring member
31 inner plate
32 outer plate
33 flange plate
35 arm spring
Pw welded portion
Pc contact portion
Pp fulcrum portion

What is claimed is:

1. A female terminal comprising a terminal body, the terminal body including:
a base portion to be connected to an electric wire; and
a spring member to be attached to the base portion, wherein
the base portion includes a pair of side walls disposed at a predetermined interval into which a male terminal can be inserted,
the spring member includes a laying plate along at least an inner side surface of each of the side walls and an arm spring extending from the laying plate toward the side wall facing the laying plate,
the side wall and the laying plate are welded to form a welded portion, and
a fulcrum portion of the arm spring abutting the side wall is provided between the welded portion and a contact portion abutting the male terminal.

2. The female terminal according to claim 1, wherein
the laying plate is disposed along a distal end surface of the side wall, and
the laying plate is welded to the distal end surface of the side wall.

3. The female terminal according to claim 1 or 2, wherein
the laying plate is disposed along an outer side surface of the side wall, and
the laying plate is welded to the outer side surface of the side wall.

4. The female terminal according to any one of claims 1 to 3, wherein the laying plate is welded to an inner side surface of the side wall.

5. The female terminal according to any one of claims 1 to 4, wherein the welded portion in at least one side wall of the pair of side walls is formed of a plurality of welded portions or a plurality of welded points.

6. The female terminal according to any one of claims 1 to 5, wherein the fulcrum portion of the arm spring is a portion abutting a protruding portion provided on the laying plate and protruding toward the side wall or a protruding portion provided on the side wall and protruding toward the laying plate.

7. The female terminal according to any one of claims 1 to 6, wherein the welded portion in at least one side wall of the pair of side walls forms one or a plurality of curved or bent-line-shaped welding patterns.

8. The female terminal according to any one of claims 1 to 7, wherein the welded portion in at least one side wall of the pair of side walls forms a welding pattern with an end in which one or a plurality of end portions are widened.

9. The female terminal according to any one of claims 1 to 7, wherein the welded portion in at least one side wall of the pair of side walls forms one or a plurality of endless welding patterns.

10. The female terminal according to claim 9, wherein the welding pattern is formed by disposing an end point of a continuous welding line at a start point of the welding line.

11. The female terminal according to claim 9, wherein
wherein the welding pattern is formed by a continuous welding line passing through a start point of the welding line and disposing an end point of the welding line in a middle portion of the welding line.

12. A connector comprising:
the female terminal according to any one of claims 1 to 11; and
a connector housing that houses the female terminal.

13. A terminal-attached electric wire comprising:
the female terminal according to any one of claims 1 to 11; and
the electric wire connected to the base portion of the female terminal.

14. A connector-attached electric wire comprising:
the terminal-attached electric wire according to claim 13; and
a connector housing that houses the terminal-attached electric wire.

15. A wire harness comprising at least one of the terminal-attached electric wire according to claim 13 and the connector-attached electric wire according to claim 14.
